(19) United States
(12) Patent Application Publication
(10) Pub. No.: US 2003/0082090 A1
(43) Pub. Date: May 1, 2003

(54) Precipitated silica with a high BET/CTAB ratio

(75) Inventors: Anke Blume, Weilerswist (DE); Stefan Uhrlandt, Niederkassel (DE); Ralf Schmoll, Bonn (DE); Detlef Luginsland, Koeln (DE); Herbert Thoma, Swisttal (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Marl (DE)

(21) Appl. No.: 10/247,330

(22) Filed: Sep. 20, 2002

(30) Foreign Application Priority Data
Sep. 20, 2001 (DE) 101 46 325.1

(51) Int. Cl. C08J 3/00; C08K 3/34; C08L 1/00; C01B 33/12

(52) U.S. Cl. 423/335; 524/492; 423/338

(57) ABSTRACT

The present invention relates to a precipitated silica having a particularly high BET/CTAB ratio, to a process for preparing it, and to its use in clastomer blends.

### BACKGROUND OF THE INVENTION

1. Field of the Invention

The present invention relates to a precipitated silica having a particularly high BET/CTAB ratio, to a process for preparing it, and to its use.

2. Description

The use of precipitated silicas in elastomer blends such as tires has been known for a long time. Silicas used in tires are subject to stringent requirements. They should be amenable to easy and thorough dispersion in the rubber, should connect well with the polymer chains present in the rubber and with the other fillers, and should have a high abrasion resistance akin to that of carbon black. Besides the dispersibility of the silica, therefore, the specific surface areas (BET or CTAB) and the oil absorption capacity (DBP) are important. The specific surface areas are a measure of the internal and external structure of the silica. Since these two methods use adsorbate molecules of different size, the ratio of these two surface characteristics (i.e., the BET/CTAB surface area quotient) provides an indication of the pore size distribution of the silica and of its ratio of “external” to “internal” surface area. The surface properties of silicas are critical determinants of their possible application: certain applications of a silica (e.g., carrier systems or fillers for elastomer blends) demand certain surface properties.

Thus U.S. Pat. No. 6,013,234 discloses the preparation of the precipitated silica having a BET and CTAB surface area of in each case from 100 to 350 m²/g. This silica is particularly suitable for incorporation into elastomer blends, with the BET/CTAB ratios being between 1 and 1.5. EP 0 937 755 discloses various precipitated silicas which possess a BET surface area of from about 180 to about 430 m²/g and a CTAB surface area of from about 160 to 340 m^{2/}g. These silicas are particularly suitable as carrier material and have a BET to CTAB ratio of from 1.1 to 1.3. EP 0 647 591 discloses a precipitated silica which has a ratio of BET to CTAB surface area of from 0.8 to 1.1, it being possible for these surface characteristics to adopt absolute values of up to 350 m²/g. EP 0 643 015 presents a precipitated silica which can be used as an abrasive component and/or thickening component in toothpastes and which has a BET surface area of from 10 to 130 m²/g and a CTAB surface area of from 10 to 70 m²/g, i.e., a BET to CTAB ratio of from about 1 to 5.21.

### SUMMARY OF THE INVENTION

It has now been found that a precipitated silica which has very different BET and CTAB surface areas while remaining above minimum values for these parameters is especially suitable as a filler in elastomer blends.

The present invention accordingly provides precipitated silicas whose BET surface area is more than 135 m²/g and whose CTAB surface area is more than 75 m ²/g, the ratio of the BET to the CTAB surface areas being ≧1.7, and a process for producing the same. In addition, the present invention provides for a vulcanizable rubber mixture or vulcanizate, and a tire comprising the precipitated silica described above.

A more complete appreciation of the invention and many of the attendant advantages thereof will be readily obtained as the same becomes better understood by reference to the following detailed description when considered with the accompanying drawings.

### BRIEF DESCRIPTION OF THE DRAWINGS

FIG. 1 shows the RPA plots of the silica of the invention (KS) in comparison with the standard silica Ultrasil VN2 GR.

FIG. 2 is a diagram of the values needed to calculate the wk coefficient.

### DETAILED DESCRIPTION OF THE PREFERRED EMBODIMENTS

The precipitated silicas of the invention may have a maximum BET surface area of 600 m²/g and/or a maximum CTAB surface area of 350 m²/g. Furthermore, the precipitated silicas may be characterized by a DBP absorption of 100-350 g/100 g, by a wk coefficient of ≦3.4 (ratio of the peak height of the particles undegradable by ultrasound, in the size range 1.0-100 μm, to the peak height of the degraded particles in the size range <1.0 μm), and/or by a Sears number of 5-25 ml.

The ratio of BET/CTAB surface area of the precipitated silica of the invention is preferably situated within the following ranges:

| BET | CTAB | BET/CTAB |
|---|---|---|
| [m²/g] | [m²/g] | ratio |
| 140 | 80 | 1.75 |
| 180 | 100 | 1.8 |
| 215 | 113 | 1.90 |
| 250 | 125 | 2 |
| 292 | 129 | 2.26 |
| 300 | 100 | 3 |
| 336 | 143 | 2.35 |
| 344 | 168 | 2.05 |
| 350 | 200 | 1.75 |
| 400 | 150 | 2.67 |
| 450 | 200 | 2.25 |
| 500 | 280 | 1.79 |
| 550 | 280 | 1.96 |
| 600 | 200 | 3 |

The present invention further provides a process for preparing a precipitated silica having a

BET surface area≧135 m²/g and a

CTAB surface area 24 75 m²/g

with a BET/CTAB surface area ratio≧1.7, by

a) initially introducing an aqueous waterglass solution,

b) metering waterglass and sulfuric acid simultaneously into this initial charge at 55-95° C. for 10-60 minutes with stirring,

c) halting the metered addition for 30-90 minutes while maintaining the temperature,

d) metering in waterglass and sulfuric acid simultaneously at the same temperature for 20-80 minutes with stirring,

e) acidifying to a pH of about 3.5 with sulfuric acid, and

f) filtering and drying the product.

The components supplied in steps b) and d) may each have identical or different concentrations and/or flow rates. In one process variant, the concentration of the components used is the same in both steps but the flow rate of the components in step d) is 125-140% of the flow rate in step b).

Besides waterglass (sodium silicate solution) it is also possible to use other silicates such as potassium silicate or calcium silicate. In place of sulfuric acid it is also possible to use other acidifiers such as HCl, HNO₃ or CO₂.

The physicochemical data of the precipitated silicas of the invention are determined by the following methods:

| | |
|---|---|
| BET surface area | Areameter from Ströhlein, in accordance with |
| | ISO 5794/Annex D |
| CTAB surface area | at pH 9, in accordance with Janzen and Kraus in |
| | Rubber Chemistry and Technology 44(1971) 1287 |
| DBP number | ASTM 2414-88 |

The filtration and drying of the silicas of the invention are familiar to the skilled worker and may be read about, for example, in the abovementioned patents. The precipitated silica is preferably dried by spray drying (in a nozzle tower) or by means of a rack drier, a flash drier or a spin-flash drier. Spray drying may be conducted in accordance, for example, with U.S. Pat. No. 4,097,771. Here, in a nozzle tower drier, a precipitated silica is produced which is obtained in particle form with an average diameter of more than 80 μm, in particular more than 90 μm, with particular preference more than 200 μm.

The silicas of the invention may therefore be used as fillers in elastomer blends, in particular for tires.

Moreover, the silicas of the invention may be used in all fields of application in which it is common to use silicas, such as, for example, in battery separators, antiblocking agents, flatting agents in paints, paper coatings or defoamers.

The invention further provides elastomer blends, vulcanizable rubber mixtures or other vulcanizates, and also tires, which comprise the silica of the invention.

Optionally, the silica of the invention may be modified with silanes or organosilanes of the formulae I to III.

[R¹ₙ—(RO)₃₋ₙSi-(Alk)ₘ—(Ar)ₚ]_{q}[B] (I),

R¹ₙ—(RO)₃₋ₙSi-(Alkyl) (II),

or

R¹ₙ(RO)₃₋ₙSi-(Alkenyl) (III),

wherein

B is —SCN, —SH, —Cl, —NH₂ (if q=1) or -Sx- (if q=2);

R and R¹ are an alkyl group having 1 to 4 carbon atoms or the phenyl radical, it being possible for all radicals R and R¹ to have in each case the same meaning or a different meaning;

R is a C₁-C₄ alkyl or C₁-C₄ alkoxy group;

n is 0, 1 or 2;

Alk is a divalent unbranched or branched hydrocarbon radical having from 1 to 6 carbon atoms,

m is 0 or 1,

Ar is an arylene radical having from 6 to 12 carbon atoms, preferably 6 carbon atoms,

p is 0 or 1 with the proviso that p and n are not both 0,

x is a number from 2 to 8,

Alkyl is a monovalent unbranched or branched saturated hydrocarbon radical having from 1 to 20 carbon atoms, preferably from 2 to 8 carbon atoms; and

Alkenyl is a monovalent unbranched or branched unsaturated hydrocarbon radical having from 2 to 20 carbon atoms, preferably from 2 to 8 carbon atoms.

The modification of the precipitated silica with organosilanes may take place in mixtures of from 0.5 to 50 parts, based on 100 parts of precipitated silica, in particular from 1 to 15 parts, based on 100 parts of precipitated silica, with the reaction between precipitated silica and organosilane being carried out during the preparation of the mixture (in situ) or externally by spray application and subsequent thermal conditioning of the mixture or by mixing the silane and the silica suspension with subsequent drying and thermal conditioning. This range for the modification of the precipitated silica with organosilanes includes all specific values and subranges therebetween, such as 5, 10, 20, 25, 30, 35, 40 and 45 parts, based on 100 parts of precipitated silica.

In one preferred embodiment of the invention, bis(triethoxysilylpropyl)-tetrasulfane can be used as silane.

The silica of the invention may be incorporated into elastomer blends, tires or vulcanizable rubber mixtures as a reinforcing filler in amounts of from 5 to 200 parts, based on 100 parts of rubber, in the form of powders, microbeads or granules, both with silane modification and without silane modification. This range for the incorporation into elastomer blends, tires or vulcanizable rubber mixtures as a reinforcing filler includes all specific values and subranges therebetween, such as 10, 20, 30, 40, 50, 60, 70, 80, 90, 100, 110, 120, 130, 140, 150, 160, 170, 180, and 190 parts, based on 100 parts of rubber.

The addition of one or more of the abovementioned silanes may take place together with the silicas of the invention to the elastomer, with the reaction between filler and silane taking place during the mixing process at elevated temperatures (in situ modification) or in already pre-modified form (for example, DE-C 40 04 781); that is, the two reactants are reacted outside of the actual preparation of the mixture.

In addition to blends which include exclusively the silicas of the invention, with and without organosilanes of formulae I to III as fillers, the elastomers may further be filled with one or more fillers having a greater or lesser reinforcing action. Primarily it would be customary here to have a blend of carbon black (for example, furnace blacks, gas blacks, lamp blacks, acetylene blacks) and the silicas of the invention, with and without silane, but also between natural fillers, such as clay, siliceous chalk, further commercial silicas, and the silicas of the invention.

Here too, as for the amount of the organosilanes, the blending ratio is guided by the target profile of properties of the finished rubber mixture. A ratio of 5-95% between the silicas of the invention and the other abovementioned fillers is conceivable and is also realized in this context.

Besides the silicas of the invention, the organosilanes, and the other fillers, the elastomers constitute a further important constituent of the rubber mixture. The silicas of the invention may be used in all types of rubber which can be crosslinked with accelerator/sulfur or else with peroxide. Mention may be made in this context of elastomers, natural and synthetic, oil-extended or otherwise, as individual polymers or as blends with other rubbers, such as natural rubbers, butadiene rubbers, isoprene rubbers, butadiene-styrene rubbers, especially SBR, prepared by means of the solution polymerization process, butadiene-acrylonitrile rubbers, butyl rubbers and terpolymers of ethylene, propylene and nonconjugated dienes. For mixtures with the aforementioned rubbers, the following additional rubbers are also suitable:

carboxyl rubbers, epoxy rubbers, trans-polypentenamers, halogenated butyl rubbers, 2-chlorobutadiene rubbers, ethylene-vinyl acetate copolymers, ethylene-propylene copolymers, and, where appropriate, chemical derivatives of natural rubber, and also modified natural rubbers.

Likewise known are the customary further constituents such as plasticizers, stabilizers, activators, pigments, aging inhibitors, and processing auxiliaries, in the customary amounts.

The silicas of the invention, with and without silane, find application in all rubber applications, such as tires, conveyor belts, seals, V-belts, hoses, soles, etc.

The invention additionally provides elastomer blends, particularly vulcanizable rubber mixtures, which contain the silicas of the invention in amounts of from 5 to 200 parts, based on 100 parts of elastomer or rubber. The incorporation of this silica and the preparation of the mixtures comprising this silica take place in the manner customary in the rubber industry, on an internal mixer or roll unit. The presentation form or use form may be that of a powder, of microbeads or of granules. In this respect too, the silicas of the invention do not differ from the known pale silicate fillers.

In order to obtain a good profile of values in a polymer mixture, the dispersion of the precipitated silica in the matrix, the polymer, is of critical importance.

It has been found that the wk coefficient is a measure of the dispersibility of a precipitated silica.

The wk coefficient is determined as follows:

The measurement is based on the principle of laser diffraction. Measurement is carried out using a Coulter LS 230.

To determine the coefficient, 1.3 g of the precipitated silica are introduced into 25 ml of water and the mixture is treated with ultrasound at 100 W (90% pulsed) for 4.5 minutes. The solution is then transferred to the measuring cell and treated with ultrasound for a further minute.

Detection by means of two laser diodes situated at different angles to the sample is carried out during the ultrasound treatment. According to the principle of the diffraction of light, the laser beams are diffracted. The resulting diffraction pattern is analyzed with computer assistance. The method allows the particle size distribution to be determined over a relatively wide measurement range (approximately 40 nm-500 μm).

An essential point here is that the introduction of energy by ultrasound represents a simulation of the input of energy by mechanical forces in industrial mixing units in the tire industry.

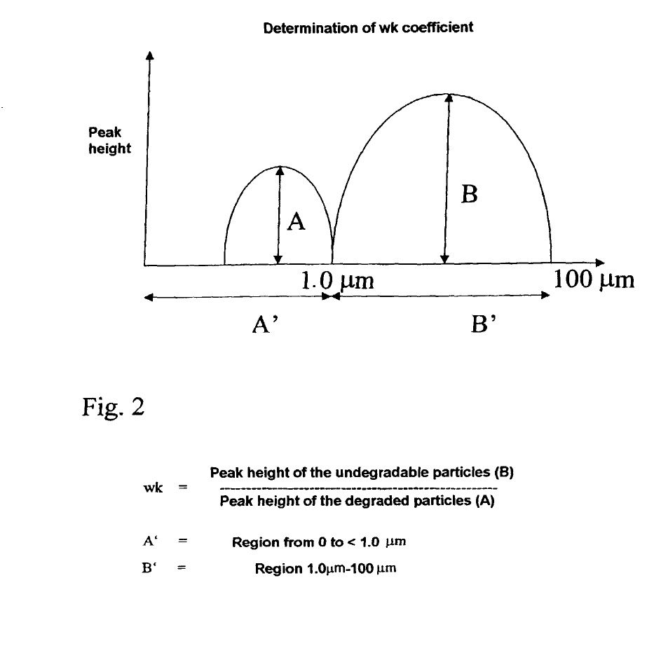

FIG. 2 is a diagram of the values needed to calculate the wk coefficient.

The plots show a first maximum in the particle size distribution in the region of 1.0-100 μm and a further maximum in the region <1.0 μm. The peak in the region 1.0-100 μm indicates the fraction of uncomminuted silica particles following the ultrasound treatment. These decidedly coarse particles are poorly dispersed in the rubber mixtures. The second peak, with markedly smaller particle sizes (<1.0 μm), indicates the silica particle fraction which has been comminuted during the ultrasound treatment. These very small particles are dispersed excellently in rubber mixtures.

The wk coefficient, then, is a ratio of the peak height of the undegradable particles (B) whose maximum is situated in the range 1.0-100 μm (B′) to the peak height of the degraded particles (A) whose maximum is situated in the range <1.0 μm (A′).

The wk coefficient is hence a measure of the “degradability” (i.e., dispersibility) of the precipitated silica. It holds that the smaller the wk coefficient, the easier it is to disperse a precipitated silica, i.e., the greater the number of particles degraded in the course of incorporation into rubber.

The silicas of the invention have wk coefficients<3.4. The maximum in the particle size distribution of the undegradable particles of the precipitated silica of the invention is situated in the range 1.0-100 μm. The maximum in the particle size distribution of the degraded particles of the precipitated silica of the invention is situated in the range<1.0 μm. Known precipitated silicas have much higher wk coefficients and different maxima in the particle size distributions measured with the Coulter LS 230, and are therefore more difficult to disperse.

The examples which follow are intended to illustrate the invention without restricting its scope.

Having generally described the invention, a further understanding can be obtained by reference to certain specific examples which are provided herein for purposes of illustration only and are not intended to be limiting unless otherwise specified.

### EXAMPLES

### Example 1

A reactor is charged with 40 l of water and with 4.3 liters of waterglass (density 1.348, 27.0% SiO₂, 8.05% Na₂O). Thereafter, 8.6 l/h waterglass and 1.6 l/h sulfuric acid (96%, density 1.400) are metered in at 75° C. for 35 minutes. After 35 minutes, the addition is interrupted for 60 minutes and then recommenced, this time metering in 11.9 l/h waterglass and 2.3 l/h sulfuric acid of the grade indicated above for 50 minutes. The addition of waterglass is then stopped and the sulfuric acid is continued until a pH of about 3.5 has been reached. The resulting product is filtered as usual and then subjected to quick drying. The product obtained has a BET surface area of 215 m²/g and a CTAB surface area of 113 m²/g.

### Example 2

The formulation used for the rubber mixtures is shown in Table 1 below. The unit phr denotes parts by weight per 100 parts of the crude rubber used. The general process for preparing rubber mixtures and their vulcanizates is described in the following text: “Rubber Technology Handbook”, W. Hofmann, Hanser Verlag 1994.

TABLE 1

| | Reference | Example |
|---|---|---|
| Substance | [phr] | [phr] |
| Stage 1 | | |
| Buna VSL 5025-1 | 96 | 96 |
| Buna CB 24 | 30 | 30 |
| Ultrasil 7000 GR | 80 | — |
| Silica of the invention | | 80 |
| ZnO | 3 | 3 |
| Stearic acid | 2 | 2 |
| Naftolene ZD | 10 | 10 |
| Vulkanox 4020 | 1.5 | 1.5 |
| Protector G35P | 1 | 1 |
| X 50-S | 12.8 | 12.8 |
| Stage 2 | | |
| Batch Stage 1 | | |
| Stage 3 | | |
| Batch Stage 2 | | |
| Vulkacit D | 2 | 2 |
| Perkacit TBzTD | 0.2 | 0.2 |
| Vulkacit CZ | 1.5 | 1.5 |
| Sulfur | 1.5 | 1.5 |

The polymer VSL 5025-1 is a solution-polymerized SBR copolymer from Bayer AG having a styrene content of 25% by weight and a butadiene content of 75% by weight. Of the butadiene, 73% is 1,2, 10% is cis-1,4 and 17% is trans-1,4 linked. The copolymer contains 37.5 phr oil and has a Mooney viscosity (ML 1+4/100° C.) of 50±4.

The polymer Buna CB 24 is a cis-1,4 polybutadiene from Bayer AG having a cis-1,4 content of 97%, a trans-1,4 content of 2%, a 1,2 content of 1%, and a Mooney viscosity of 44±5.

The aromatic oil used was Naftolen ZD from Chemetall; Vulkanox 4020 is 6PPD from Bayer AG and Protektor G35P is an ozone protection wax from HB Fuller GmbH. Vulkacit D (DPG) and Vulkacit CZ (CBS) are commercial products from Bayer AG. Perkacit TBzTD is available from Flexsys.

The coupling reagent X50-D is a 50/50blend of Si 69 from Degussa AG and carbon black N 330. Ultrasil 7000 GR is an easily dispersible precipitated silica from Degussa AG having a BET surface area of 170 m²/g.

The rubber mixtures were prepared in accordance with the mixing instructions shown in Table 2.

TABLE 2

| Stage 1 | |
|---|---|
| Settings | |
| Mixing unit | Werner & Pfleiderer N type |
| Rotary speed | 70 min⁻¹ |
| Ram pressure | 5.5 bar |
| Empty volume | 1.6 L |
| Fill level | 0.73 |
| Flow temperature | 70° C. |
| Mixing operation | |
| 0 to 1 min | BUNA VSL 5025-1 + Buna CB 24 |
| 1 to 3 min | ½ silica, X50-S |
| 3 to 5 min | ½ silica, remainder of Stage 1 chemicals |
| 4 min | Clean |
| 4 to 5 min | Mix and discharge |
| Batch temperature | 145-150° |
| Storage | 24 h at room temperature |
| Stage 2 | |
| Settings | |
| Mixer | As in Stage 1 except for: |
| Rotary speed | 80 min⁻¹ |
| Flow temperature | 80° C. |
| Fill level | 0.70 |
| Mixing operation | |
| 0 to 2 min | Break open Stage 1 batch |
| 2 to 5 min | Maintain batch temperature of 150° C. by speed |
| 5 min | variation Discharge |
| | 150° C. |
| Batch temperature | 24 h at room temperature |
| Storage | |
| Stage 3 | |
| Settings | |
| Mixer | As in Stage 1 except for: |
| Rotary speed | 40 min⁻¹ |
| Fill level | 0.69 |
| Flow temperature | 50° C. |
| Mixing operation | |
| 0 to 2 min | Batch Stage 2, accelerator, sulfur |
| 2 min | Discharge and form sheet on laboratory mixing roll |
| | unit (diameter 200 mm, length 450 mm, flow |
| | temperature 50° C.) |
| | Homogenizing: |
| | cut in 3* left, 3* right and fold over, and tumble for |
| | 10* with a wide roll nip (3.5 mm) |
| | Pull out sheet |
| Batch temperature | 85-95° C. |

In Table 3, the methods for rubber testing are compiled.

TABLE 3

| Physical Testing | Standard/Conditions |
|---|---|
| ML 1 + 4, 100° C., Stage 3 | DIN 53523/3, ISO 667 |
| Vulkameter testing, 165° C. | DIN 53529/3, ISO 6502 |
| Dmax - Dmin [dNm] | |
| t10% and t90% [min] | |
| Tensile test on ring, 23° C. | DIN 53504, ISO 37 |
| Strain values [MPa] | |
| Elongation at break [%] | |
| Shore A hardness, 23° C. [SH] | DIN 53 505 |
| Viscoelastic properties, | DIN 53 513, ISO 2856 |
| 0 and 60° C., 16 Hz, 50 N initial force | |
| and 25 N amplitude force | |
| Storage modulus E* [MPa] | |
| Loss factor tan δ [] | |
| Goodrich Flexometer, heat buildup | DIN 53533, ASTM D 623 A |
| 25 min, 0.25 inch stroke | |
| Internal temperature [° C.] | |
| Permanent Set [%] | |
| Ball rebound, 23° C., 60° C. [%] | ASTM D 5308 |
| DIN abrasion, 10 N force [mm³] | DIN 53516 |

The results of rubber industry testing of the reference mixture with Ultrasil 7000 GR and the silica of the invention according to Example 1 are shown comparatively in Table 4.

TABLE 4
Results of rubber industry testing

| | | Ref. | Exp. |
|---|---|---|---|
| ML 1 + 4 | [ME] | 63 | 67 |
| Dmax-Dmin | [dNm] | 18.4 | 17.5 |
| t10% | [min] | 1.3 | 2.2 |
| t90% | [min] | 6.2 | 5.6 |
| t90%-t10% | [min] | 4.9 | 3.4 |
| Shore A hardness | [SH] | 67 | 66 |
| Strain value 100% | [MPa] | 2.1 | 2.9 |
| Strain value 300% | [MPa] | 10.3 | 11.8 |
| Elongation at break | [%] | 390 | 320 |
| DIN abrasion | [mm³] | 77 | 85 |
| Ball rebound 60° C. | [%] | 54.9 | 64.8 |
| Heat buildup | [° C.] | 111 | 90 |
| Permanent set | [%] | 5.9 | 1.9 |
| E* (0° C.) | [MPa] | 25.4 | 16.9 |
| tan δ (0° C.) | [] | 0.471 | 0.396 |
| E* (60° C.) | [MPa] | 8.9 | 8.5 |
| tan δ (60° C.) | [] | 0.128 | 0.095 |

As can be seen from the data in Table 1, the ML 1+4 viscosities of the two mixtures are at a comparable level despite the highly different CTAB surface areas, which suggests good processability of the silica of the invention.

The scorch time t 10% is advantageously extended for the mixture of the example, and the crosslinking rate t 90%-t 10% is increased.

Furthermore, the mixture of the example features higher strain values at similar Shore A hardness, despite the fact that the CTAB surface area of the silica of the invention is much lower than that of Ultrasil 7000 GR. The skilled worker is aware that only an increase in the CTAB surface area of the silica leads already to higher viscosities and Shore A hardnesses. Accordingly, the silica of the invention with the high BET/CTAB surface area ratio possesses an excellent reinforcing behavior.

From the dynamic data, distinct advantages of the silica of the invention can be seen in terms of the hysteresis loss. As compared with the reference mixture, the ball rebound at 60° C. is increased in the mixture of the example, the heat buildup in the Goodrich flexometer is lowered, and the tan δ at 60° C. as well is advantageously lowered, suggesting a reduced rolling resistance in a tire tread mixture.

In Examples 3 and 4, the following substances were used:

| | |
|---|---|
| Krynol 1712 | styrene-butadiene rubber based on emulsion |
| | polymerization |
| Buna VSL 5025-0 | styrene-butadiene rubber based on solution |
| | polymerization |
| Buna CB 10 | butadiene rubber |
| SMR 10 | natural rubber, ML(1 + 4) = 60-70 |
| X 50 S | 50:50 blend of Si 69/bis(3- |
| | triethoxysilylpropyl)tetrasulfane |
| Corax N 375 | standard carbon black |
| ZnO RS | zinc oxide |
| Stearic acid | |
| Naftolen | aromatic oil |
| Protektor G35P | ozone protection wax |
| Lipoxol 4000 | polyethylene glycol |
| Vulkanox 4020 | N-(1,3-dimethylbutyl)-N′-phenyl-p-phenylenediamine |
| Vulkanox HS/LG | 2,2,4-trimethyl-1,2-dihydroquinoline, oligomerized |
| DPG | diphenylguanidine |
| CBS | N-cyclohexyl-2-benzothiazylsulfenamide |
| ZBEC | zinc dibenzyldithiocarbamate |
| Sulfur | |

### Example 3

Precipitated silica of the invention in comparison with the standard silica Ultrasil VN2 GR (Degussa AG) in a straight E-SBR mixture (amounts in phr):

| | | Silica of |
|---|---|---|
| | VN2 | Example 1 |
| Krynol 1712 | 137.5 | 137.5 |
| Ultrasil VN2 GR | 50 | — |
| Silica of the invention | — | 50 |
| X 50 S | 3 | 3 |
| ZnO RS | 3 | 3 |
| Stearic acid | 1 | 1 |
| Vulkanox 4020 | 2 | 2 |
| Lipoxol 4000 | 1.5 | 1.5 |
| DPG | 1.5 | 1.5 |
| CBS | 1.5 | 1.5 |
| Sulfur | 2.2 | 2.2 |
| Vulcanizate data: 160° C. | 4.7 | 4.4 |
| t₉₀-t₁₀ [%] | | |
| 100% modulus [MPa] | 1.1 | 1.5 |
| 300% modulus [MPa] | 4.8 | 5.8 |
| E* 60° C. | 5.4 | 6.2 |
| tan δ 60° C. | 0.085 | 0.085 |
| E* 0° C. | 7.9 | 8.9 |
| Dispersion, peak area topography | 3.9 | 2.0 |
| Dispersion, number of peaks 2-5 μm | 32 | 26 |
| Wet slippage LAT 100 rating [%] | 100 | 106 |
| (mean values of the temperature evaluation) | | |

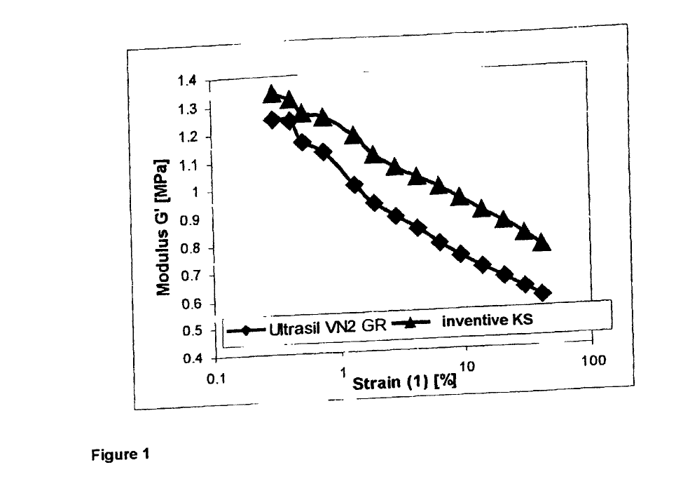

FIG. 1 shows the RPA plots of the silica of the invention (KS) in comparison with the standard silica Ultrasil VN2 GR.

As compared with the standard silica Ultrasil VN2 GR, the silica of the invention leads to higher moduli values, higher E* values, and a markedly improved dispersion (corresponding to better abrasion characteristics). In the RPA plots shown in FIG. 1, it is evident that the use of the silica of the invention leads both to a higher filler-filler network and to a markedly higher filler-polymer interaction, which means that the silica of the invention exhibits a considerably better reinforcing behavior. Furthermore, the use of the silica of the invention displays greatly improved wet slippage as compared with the standard silica Ultrasil VN2 GR.

### Example 4

Precipitated silica of the invention as compared with the standard silica Ultrasil VN2 GR in a winter tire mixture (amounts in phr):

| | 1 | 2 |
|---|---|---|
| Buna VSL 5025-0 | 40 | 40 |
| Buna CB 10 | 45 | 45 |
| SMR 10 | 15 | 15 |
| Ultrasil VN2 GR | 70 | — |
| Silica of the invention | — | 70 |
| X 50 S | 6 | 6 |
| Corax N 375 | 20 | 20 |
| ZnO RS | 3 | 3 |
| Stearic acid | 2 | 2 |
| Vulkanox 4020 | 1 | 1 |
| Naftolen ZD | 35 | 35 |
| Protektor G35P | 1.5 | 1.5 |
| Vulkanox HS/LG | 1 | 1 |
| DPG | 1.7 | 1.7 |
| CBS | 1.7 | 1.7 |
| ZBEC | 0.1 | 0.1 |
| Sulfur | 1.4 | 1.4 |
| Vulcanizate data: 160° C. | 6.5 | 6.9 |
| t₉₀ [%] | | |
| 100% modulus [MPa] | 1.7 | 2.2 |
| 300% modulus [MPa] | 7.5 | 8.1 |
| Shore hardness | 64 | 64 |
| E* 60° C. | 9.3 | 9.8 |
| tan δ 60° C. | 0.201 | 0.188 |
| 1/E* −20° C. | 1.5 | 2.3 |
| tan δ −20° C. | 0.426 | 0.474 |
| Dispersion, peak area topography | 1.2 | 1.8 |
| Permanent set [%] | 13.8 | 10.9 |
| Heat buildup [° C.] | 154 | 145 |

As compared with the standard silica Ultrasil VN2 GR, the silica of the invention leads to higher moduli values, to a lower heat buildup (corresponding to a longer lifetime), to equally good dispersion values, to higher E* values, to a lower tanδ 60° C. (corresponding to improved rolling resistance), and to a higher 1/E* at −20° C. (compliance), corresponding to improved grip on snow.

### Example 5

A reactor is charged with 40 l of water and with 4.6 l of waterglass (density 1.348, 27.0% SiO₂, 8.05% Na₂O). Thereafter, 8.7 l/h waterglass and 1.7 l/h sulfuric acid (96%, density 1.400) are metered in at 70° C. for 35 minutes. After 35 minutes, the addition is interrupted for 60 minutes and then recommenced, this time metering in 11.9 l/h waterglass and 2.4 l/h sulfuric acid of the grade indicated above for 50 minutes. The addition of waterglass is then stopped and the sulfuric acid is continued until a pH of about 3.5 has been reached. The resulting product is filtered as usual and then subjected to quick drying. The product obtained has a BET surface area of 292 m²/g and a CTAB surface area of 129 m²/g.

The BET/CTAB ratio is 2.26.

### Example 6

As Example 5, with the temperature being 65° C. The product obtained has a BET surface area of 336 m²/g and a CTAB surface area of 143 m²/g.

The BET/CTAB ratio is 2.35.

### Example 7

As Example 5, with the temperature being 60° C. The product obtained has a BET surface area of 344 m²/g and a CTAB surface area of 168 m²/g.

The BET/CTAB ratio is 2.05.

Obviously, numerous modifications and variations of the present invention are possible in light of the above teachings. It is therefore to be understood that within the scope of the appended claims, the invention may be practiced otherwise than as specifically described herein.

Each document, patent application or patent publication cited by or referred to in this disclosure is incorporated by reference in its entirety. Specifically, priority application DE 10146325.1, filed Sep. 20, 2001, is hereby incorporated by reference.

What is claimed is:

1. A precipitated silica having a
BET surface area≧135 m²/g
CTAB surface area≧75 m²/g
wherein the BET/CTAB surface area ratio is ≧1.7.

2. The precipitated silica as claimed in claim 1, wherein said BET surface area is at most 600 m²/g.

3. The precipitated silica as claimed in claim 1, wherein said CTAB surface area is at most 350 m²/g.

4. The precipitated silica as claimed in claim 1, having a DBP absorption of 100-350 g/100 g.

5. The precipitated silica as claimed in claim 1, having a wk coefficient of ≦3.4, wherein said wk coefficient is a ratio of the peak height of the particles undegradable by ultrasound in the size range 1.0-100 μm to the peak height of the degraded particles in the size range <1.0 μm.

6. The precipitated silica as claimed in claim 1, having a surface which has been modified with at least one organosilane of the formula I, II or III
[R¹ₙ—(RO)₃₋ₙSi-(Alk)ₘ-(Ar)ₚ]_{q}[B] (I)
R¹ₙ—(RO)₃₋ₙSi-(Alkyl) (II)
R¹ₙ—(RO)₃₋ₙSi-(Alkenyl) (III)

| | |
|---|---|
| B | is —SCN, —SH, —Cl, —NH₂ (if q = 1) or —Sx— (if |
| | q = 2); |
| R and R¹ | are an alkyl group having 1 to 4 carbon atoms |
| | or the phenyl radical, it being possible for all |
| | radicals R and R¹ to have in each case the |
| | same meaning or a different meaning; |
| R | is a C₁-C₄ alkyl or C₁-C₄ alkoxy group; |
| n | is 0, 1 or 2; |
| Alk | is a divalent unbranched or branched |
| | hydrocarbon radical having from 1 to 6 |
| | carbon atoms, |
| m | is 0 or 1, |
| Ar | is an arylene radical having from 6 to 12 |
| | carbon atoms, preferably 6 carbon atoms, |
| p | is 0 or 1 with the proviso that p and n are not |
| | both 0, |
| x | is a number from 2 to 8, |
| Alkyl | is a monovalent unbranched or branched |
| | saturated hydrocarbon radical having from 1 |
| | to 20 carbon atoms, preferably from 2 to 8 |
| | carbon atoms; |
| Alkenyl | is a monovalent unbranched or branched |
| | unsaturated hydrocarbon radical having from |
| | 2 to 20 carbon atoms, preferably from 2 to 8 |
| | carbon atoms; and |
| q | is 1 or 2. |

7. The precipitated silica as claimed in claim 1, having an average particle diameter of more than 80 μm.

8. A process for preparing a precipitated silica, comprising:
a) forming an aqueous waterglass solution,
b) metering waterglass and sulfuric acid simultaneously into said aqueous waterglass solution at a temperature of 55-95° C. for 10-60 minutes with stirring,
c) halting said metering for 30-90 minutes while maintaining said temperature of 55-95° C.,
d) metering in waterglass and sulfuric acid simultaneously into said aqueous waterglass solution at said temperature of 55-95° C. for 20-80 minutes with stirring to form a silica suspension,
e) acidifying to a pH of about 3.5 with sulfuric acid, and
f) filtering and drying said precipitated silica,
wherein said precipitated silica has BET surface area ≧135 m²/g, CTAB surface area ≧75 m²/g, and BET/CTAB surface area ratio ≧1.7.

9. The process as claimed in claim 8, wherein said waterglass and sulfuric acid supplied in steps b) and d) each have an identical or a different concentration.

10. The process as claimed in claim 8, wherein said waterglass and sulfuric acid supplied in steps b) and d) each have an identical or a different feed rate.

11. The process as claimed in claim 10, wherein steps b) and d) have an equal concentration of said waterglass and sulfuric acid in and step d) has a feed rate of 125-140% of the feed rate in step b).

12. The process as claimed in claim 8, wherein said drying is carried out using a spray drier, rack drier, flash drier or spin-flash drier.

13. The process as claimed in claim 8, further comprising granulating said precipitated silica with a roll compactor after said drying.

14. The process as claimed in claim 8, further comprising modifying said precipitated silica with from 0.5 to 50 parts, based on 100 parts of precipitated silica, of at least one organosilane of the formula I, II or III
[R¹ₙ—(RO)₃₋ₙSi-(Alk)ₘ-(Ar)ₚ]_{q}[B] (I)
R¹ₙ—(RO)₃₋ₙSi-(Alkyl) (II)
or
R¹ₙ(RO)₃₋ₙSi-(Alkenyl) (III)
wherein

| | |
|---|---|
| B | is —SCN, —SH, —Cl, —NH₂ (if q = 1) or —Sx— (if |
| | q = 2); |
| R and R¹ | are an alkyl group having 1 to 4 carbon atoms |
| | or the phenyl radical, it being possible for all |
| | radicals R and R¹ to have in each case the |
| | same meaning or a different meaning; |
| R | is a C₁-C₄ alkyl or C₁-C₄ alkoxy group; |
| n | is 0, 1 or 2; |
| Alk | is a divalent unbranched or branched |
| | hydrocarbon radical having from 1 to 6 |
| | carbon atoms, |
| m | is 0 or 1, |
| Ar | is an arylene radical having from 6 to 12 |
| | carbon atoms, preferably 6 carbon atoms, |
| p | is 0 or 1 with the proviso that p and n are not |
| | both 0, |
| x | is a number from 2 to 8, |
| Alkyl | is a monovalent unbranched or branched |
| | saturated hydrocarbon radical having from 1 |
| | to 20 carbon atoms, preferably from 2 to 8 |
| | carbon atoms; |
| Alkenyl | is a monovalent unbranched or branched |
| | unsaturated hydrocarbon radical having from |
| | 2 to 20 carbon atoms, preferably from 2 to 8 |
| | carbon atoms; and |
| q | is 1 or 2, |

wherein said modifying is carried out during said forming of said aqueous waterglass solution, by spray application of said organosilicone to said aqueous waterglass solution and subsequent thermal conditioning of the mixture or by mixing said organosilane and said silica suspension with subsequent drying and thermal conditioning.

15. The process as claimed in claim 7, wherein said precipitated silica is modified with from 0.5 to 50 parts, based on 100 parts of precipitated silica, of at least one organosilane.

16. The process as claimed in claim 7, wherein said precipitated silica is modified with from 1 to 15 parts, based on 100 parts of precipitated silica, of at least one organosilane.

17. A vulcanizable rubber mixture or vulcanizate comprising the precipitated silica as claimed in claim 1.

18. A tire comprising a precipitated silica as claimed in claim 1.

19. A tire comprising a precipitated silica as claimed in claim 1, wherein said precipitated silica is incorporated as a reinforcing filler in amounts of from 5 to 200 parts, based on 100 parts of rubber.

20. A vulcanizable rubber mixture or vulcanizate comprising the precipitated silica as claimed in claim 1, wherein said said precipitated silica is incorporated as a reinforcing filler in amounts of from 5 to 200 parts, based on 100 parts of rubber.
